(19) United States
(12) Patent Application Publication
(10) Pub. No.: US 2024/0362955 A1
(43) Pub. Date: Oct. 31, 2024

(54) SYSTEM AND METHOD FOR MONITORING A VEHICLE STOPPING EVENT

(71) Applicant: GM GLOBAL TECHNOLOGY OPERATIONS LLC, Ditroit, MI (US)

(72) Inventors: Noah Stone, West Bloomfield, MI (US); Matthew E. Gilbert-Eyres, Rochester Hills, MI (US); Russell A. Patenaude, Macomb Township, MI (US); Eric T. Hosey, Royal Oak, MI (US)

(73) Assignee: GM GLOBAL TECHNOLOGY OPERATIONS LLC, Detroit, MI (US)

(21) Appl. No.: 18/307,888

(22) Filed: Apr. 27, 2023

(51) Int. Cl. G07C 5/00; G06F 40/30; G06F 40/58; G07C 5/08; H04W 4/46; H04W 4/80

(52) U.S. Cl. CPC G07C 5/008; G06F 40/30; G06F 40/58; G07C 5/0808; H04W 4/46; H04W 4/80

(57) ABSTRACT

An interaction monitoring system for a subject vehicle includes: a spatial monitoring system including a video camera, a microphone, and an audio speaker; a telematics system; a vehicle monitoring system; and a controller. The controller includes an instruction set that is executable to periodically determine, via the vehicle monitoring system, operating parameters for the subject vehicle, and detect occurrence of a vehicle stopping event being commanded by a security person. The operating parameters are captured for a predetermined period of time immediately preceding the vehicle stopping event. During the stopping event, the video camera and the microphone monitor an interaction between a vehicle operator and the security person. The interaction between the vehicle operator and the security person is evaluated, and a third-party advisor is engaged based upon the interaction between the vehicle operator and the security person.

### INTRODUCTION

Vehicles may be equipped with monitoring systems, cameras, navigation systems, etc. that may enhance vehicle operation.

Vehicle operators may be compelled to pull over and stop, such as in response to a command by an authority figure, security personnel, or another individual. A vehicle operator may question an underlying basis or reason for compelling the pullover event. A pullover event may induce stress in the vehicle operator and others.

### SUMMARY

The concepts described herein include a method, system, and apparatus that are arranged and configured to provide an interaction monitoring system for a subject vehicle that includes: a spatial monitoring system including a video camera, a microphone, and an audio speaker; a telematics system, the telematics system being configured to communicate with a remote facility; a vehicle monitoring system; and a controller. The controller is in communication with the spatial monitoring system, the microphone and the audio speaker, the vehicle monitoring system, and the telematics system. The controller includes an instruction set that is executable to periodically determine, via the vehicle monitoring system, a plurality of operating parameters for the subject vehicle, and detect occurrence of a vehicle stopping event being commanded by a security person. The plurality of operating parameters are captured for a predetermined period of time immediately preceding the vehicle stopping event. During the stopping event, the video camera and the microphone monitor an interaction between a vehicle operator and the security person. The interaction between the vehicle operator and the security person is evaluated, and a third-party advisor is engaged via the telematics system based upon the interaction between the vehicle operator and the security person. Communication between the vehicle operator, the security person, and the third-party advisor occurs during the vehicle stopping event via the telematics system, the microphone and the audio speaker.

An aspect of the disclosure may include the instruction set being executable to capture the interaction between the vehicle operator and the security person; and communicate, via the telematics system, the interaction between the vehicle operator and the security person to the remote facility subsequent to termination of the vehicle stopping event.

Another aspect of the disclosure may include the instruction set being executable to communicate, via the telematics system, the plurality of operating parameters for the predetermined period of time immediately preceding the vehicle stopping event to the remote facility subsequent to termination of the vehicle stopping event.

Another aspect of the disclosure may include the instruction set including a speech analytics routine, wherein the speech analytics routine is executable to evaluate the interaction between the vehicle operator and the security person.

Another aspect of the disclosure may include the instruction set being executable to engage the third-party advisor via the telematics system based upon an evaluation, by the speech analytics routine, of the interaction between the vehicle operator and the security person.

Another aspect of the disclosure may include the instruction set being executable to engage the third-party advisor via the telematics system when the evaluation, by the speech analytics routine, of the interaction between the vehicle operator and the security person indicates an escalation of tension between the vehicle operator and the security person.

Another aspect of the disclosure may include the instruction set being executable to engage the third-party advisor via the telematics system when the evaluation, by the speech analytics routine, of the interaction between the vehicle operator and the security person indicates the vehicle operator has requested engagement of the third-party advisor.

Another aspect of the disclosure may include the telematics system including a short-range communication system; wherein the short-range communication system effects vehicle-to-vehicle (V2V) communication; and wherein the controller is in communication with the telematics system to effect V2V communication with a proximal vehicle to convey occurrence of the vehicle stopping event for the subject vehicle.

Another aspect of the disclosure may include an electronic visual display in communication with the controller; wherein the controller, the microphone, the audio speaker, and the electronic visual display interact to present a visual display containing information related to the vehicle stopping event.

Another aspect of the disclosure may include the controller including a language interpretation routine, wherein the controller including the language interpretation routine, the microphone, the audio speaker, and the electronic visual display interact to present the visual display containing information related to the vehicle stopping event, wherein the visual display is translated to a second language upon detection that the vehicle operator is a non-English language speaker.

Another aspect of the disclosure may include the instruction set being executable to determine, via the vehicle monitoring system, in-cabin activity in the subject vehicle during the vehicle stopping event; and communicate the in-cabin activity to the security person during the vehicle stopping event.

Another aspect of the disclosure may include an interaction monitoring system for a subject vehicle that includes a video camera, a microphone, an audio speaker, a telematics system, the telematics system being configured to communicate with a remote facility, a vehicle monitoring system; and a controller. The controller is in communication with the video camera, the microphone and the audio speaker, the vehicle monitoring system, and the telematics system. The controller includes an instruction set that is executable to periodically determine, via the vehicle monitoring system, a plurality of operating parameters for the subject vehicle, detect occurrence of a compulsory vehicle stopping event, capture the plurality of operating parameters for a predetermined period of time immediately preceding the vehicle stopping event, monitor, via the video camera and the microphone, an interaction between a vehicle operator and a second person, evaluate the interaction between the vehicle operator and the second person. engage a third-party advisor via the telematics system based upon the interaction between the vehicle operator and the second person, and effect communication between the vehicle operator, the second person, and the third-party advisor during the vehicle stopping event via the telematics system, the video camera, the microphone, and the audio speaker.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 pictorially illustrates a subject vehicle, in accordance with the disclosure.

FIG. 2 pictorially illustrates a driver information center for an embodiment of the subject vehicle, in accordance with the disclosure.

FIG. 3 schematically illustrates a flowchart for monitoring a vehicle stopping event, in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

Furthermore, the disclosure, as illustrated and described herein, may be practiced in the absence of an element that is not specifically disclosed herein.

The following detailed description is merely exemplary in nature and is not intended to limit the application and uses. Furthermore, there is no intention to be bound by any expressed or implied theory presented herein. Throughout the drawings, corresponding reference numerals indicate like or corresponding parts and features.

As employed herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

The use of ordinals such as first, second and third does not necessarily imply a ranked sense of order, but rather may only distinguish between multiple instances of an act or structure.

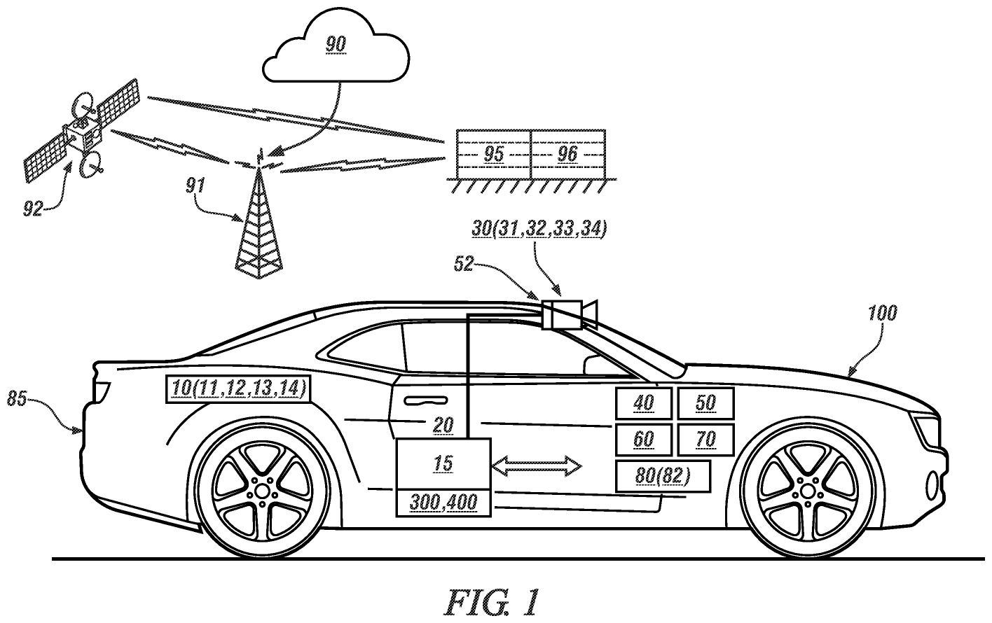

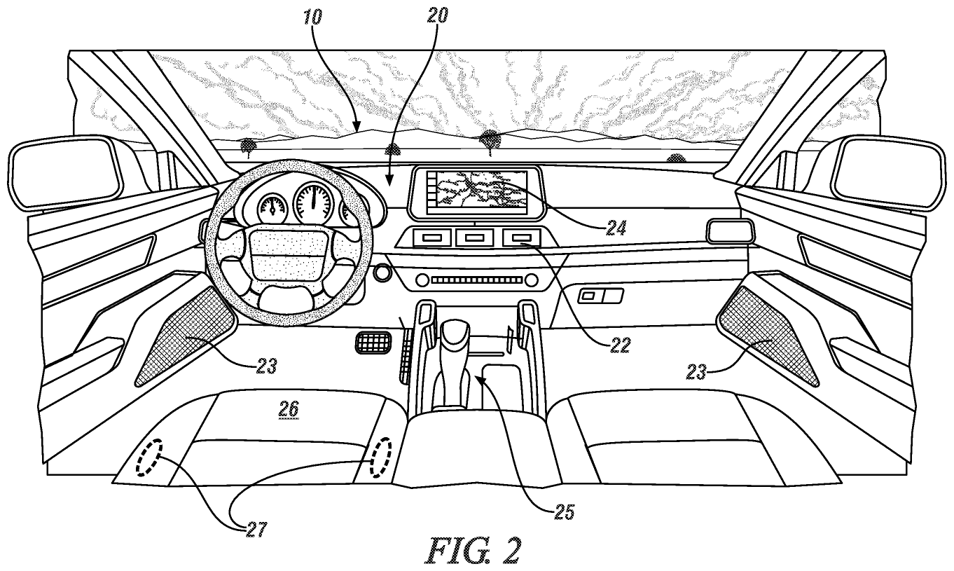

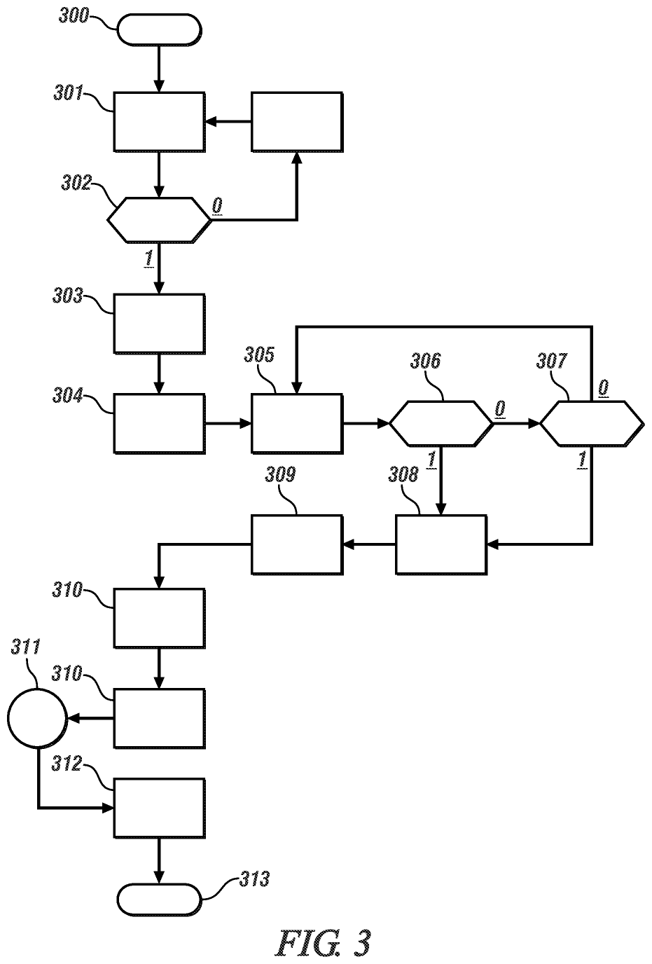

Referring to the drawings, wherein like reference numerals correspond to like or similar components throughout the several Figures, FIGS. 1 and 2, consistent with embodiments disclosed herein, illustrate elements of a subject vehicle 100 that is arranged to execute an embodiment of an interaction monitoring system 300 that may be employed during a vehicle stopping event. Details related to the interaction monitoring system 300 are described with reference to FIG. 3. The subject vehicle 100 may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure.

Referring again to FIGS. 1 and 2, the subject vehicle 100 is disposed on and able to traverse a travel surface such as a paved road surface. The subject vehicle 100 includes, in one embodiment, a vehicle operating system 10, a passenger compartment 20, a spatial monitoring system 30, a human/machine interface (HMI) system 60, a telematics system 70, and a vehicle monitoring system 80. In one embodiment, the subject vehicle 100 includes an advanced driver assistance system (ADAS) 40. In one embodiment, the subject vehicle 100 includes a navigation system 50 including a global positioning system (GPS) sensor 52.

The vehicle operating system 10 is composed of a propulsion system 11, a steering system 12, a braking system 13, and a suspension system 14. Operations of the various elements of the vehicle operating system 10 are controlled by one or multiple controllers, collectively referred to herein as a first controller 15, in response to operator inputs to operator controls 25. The vehicle monitoring system 80 includes a plurality of sensors and calibrated routines that are arranged to monitor a plurality of operating parameters 82 of the vehicle operating system 10, including, e.g., vehicle speed, acceleration, braking, yaw rate, roll, pitch, etc. The first controller 15 includes algorithmic code for execution of an interaction monitoring system 300 and an on-board speech analytics routine 400, as described with reference to FIG. 3.

The operator controls 25 may be included in the passenger compartment 20 of the subject vehicle 100, and may include, by way of non-limiting examples, an accelerator pedal, a steering wheel, a brake pedal, a turn signal indicator, a suspension selection switch, a transmission range selector (PRNDL), a cruise control actuator, an ADAS actuator, a parking brake, and/or other operator-controlled devices. Other examples of operator controls 25 for operator-controlled devices may include a trunk release switch, a glove compartment release switch, a 4WD/AWD activation switch, a door opening switch, etc. The operator controls 25 may also include an operator interface device that is an element of the HMI system 60, such as a visual display system 24 that includes a touch screen. The operator controls 25 enable a vehicle operator to interact with and direct operation of the subject vehicle 100 in functioning to provide passenger transportation, navigation, infotainment, environmental comfort, etc., and to gain access to recessed areas on-vehicle.

The navigation system 50 may include a global positioning system (GPS) sensor 52, and may be employed via the HMI system 60.

The spatial monitoring system 30 advantageously includes, by way of non-limiting examples, a video camera 31, a microphone 32, an audio speaker 33, and/or one or multiple spatial sensors 34.

The spatial monitoring system 30 may also include, in one embodiment, one or a plurality of spatial sensors 34 and systems that are arranged to monitor a viewable region that is peripheral to and/or forward of the subject vehicle 100, and a spatial monitoring controller. The spatial sensors 34 that are arranged to monitor the viewable region may include, e.g., the video camera 31, a lidar sensor, a radar sensor, and/or another device. Each of the spatial sensors 34 is disposed on-vehicle to monitor at least a portion of the viewable region to detect proximate remote objects such as road features, lane markers, buildings, pedestrians, road signs, traffic control lights and signs, other vehicles, and geographic features that are proximal to the subject vehicle 100. The spatial monitoring controller generates digital representations of the viewable region based upon data inputs from the spatial sensors. The spatial monitoring controller includes executable code to evaluate inputs from the spatial sensors to determine a linear range, relative speed, and trajectory of the subject vehicle 100 in view of each proximate remote object. The spatial sensors can be located at various locations on the subject vehicle 100 including the front corners, rear corners, rear sides and mid-sides. The spatial sensors can include a front radar sensor and a camera in one embodiment, although the disclosure is not so limited. Placement of the spatial sensors permits the spatial monitoring controller to monitor traffic flow including proximate vehicles, intersections, lane markers, and other objects around the subject vehicle 100.

The ADAS system 40 is configured to implement autonomous driving or advanced driver assistance system (ADAS) vehicle functionalities. Such functionality may include an on-vehicle control system that is capable of providing a level of driving automation. The terms ‘driver’ and ‘operator’ describe the person responsible for directing operation of the subject vehicle 100, whether actively involved in controlling one or more vehicle functions or directing autonomous vehicle operation. Driving automation can include a range of dynamic driving and vehicle operation. Driving automation can include some level of automatic control or intervention related to a single vehicle function, such as steering, acceleration, and/or braking, with the driver continuously having overall control of the subject vehicle 100. Driving automation can include some level of automatic control or intervention related to simultaneous control of multiple vehicle functions, such as steering, acceleration, and/or braking, with the driver continuously having overall control of the subject vehicle 100. Driving automation can include simultaneous automatic control of vehicle driving functions that include steering. acceleration, and braking, wherein the driver cedes control of the vehicle for a period of time during a trip. Driving automation can include simultaneous automatic control of vehicle driving functions, including steering, acceleration, and braking, wherein the driver cedes control of the subject vehicle 100 for an entire trip. Driving automation includes hardware and controllers configured to monitor the spatial environment under various driving modes to perform various driving tasks during dynamic vehicle operation. Driving automation can include, by way of non-limiting examples, cruise control, adaptive cruise control, lane-change warning, intervention and control, automatic parking, acceleration, braking, and the like. The autonomous vehicle functions include, by way of non-limiting examples, an adaptive cruise control (ACC) operation, lane guidance and lane keeping operation, lane change operation, steering assist operation, object avoidance operation, parking assistance operation, vehicle braking operation, vehicle speed and acceleration operation, vehicle lateral motion operation, e.g., as part of the lane guidance, lane keeping and lane change operations, etc. As such, the braking command can be generated by the ADAS 40 independently from an action by the vehicle operator and in response to an autonomous control function.

The HMI system 60 provides for human/machine interaction, for purposes of directing operation of an infotainment system, the global positioning system (GPS) sensor 52, the navigation system 50, and the like, and includes a controller. The HMI system 60 monitors operator requests via operator interface device(s), and provides information to the operator including status of vehicle systems, service and maintenance information via the operator interface device(s). The HMI system 60 communicates with and/or controls operation of one or a plurality of the operator interface devices, wherein the operator interface devices are capable of transmitting a message associated with operation of one of the autonomic vehicle control systems. The HMI system 60 may also communicate with one or more devices that monitor biometric data associated with the vehicle operator, including, e.g., eye gaze location, posture, and head position tracking, among others. The HMI system 60 is depicted as a unitary device for case of description, but may be configured as a plurality of controllers and associated sensing devices in an embodiment of the system described herein. Operator interface devices can include devices that are capable of transmitting a message urging operator action, and may include the visual display system 24. In one embodiment, the visual display system 24 is an electronic visual display module, e.g., a liquid crystal display (LCD) device having touch-screen capability, and/or a heads-up display (HUD). Other operator interface devices may include, e.g., an audio feedback device, a wearable device, and a haptic seat such as the driver's seat 26 that includes a plurality of haptic devices 27. The operator interface devices that are capable of urging operator action are preferably controlled by or through the HMI system 60. The HUD may project information that is reflected onto an interior side of a windshield of the vehicle, in the field-of-view of the operator, including transmitting a confidence level associated with operating one of the autonomic vehicle control systems. The HUD may also provide augmented reality information, such as lane location, vehicle path, directional and/or navigational information, and the like.

The subject vehicle 100 may include telematics system 70, or alternatively, another wireless communication device. The telematics system 70 includes a wireless telematics communication system capable of extra-vehicle communication, including communicating with a wireless communication network 100 having wireless and wired communication capabilities. The extra-vehicle communications may include short-range vehicle-to-vehicle (V2V) communication and/or vehicle-to-everything (V2x) communication, which may include communication with an infrastructure monitor, e.g., a traffic camera. Alternatively or in addition, the telematics system 70 may include wireless telematics communication systems that are capable of short-range wireless communication to a handheld device, e.g., a cell phone, a satellite phone or another telephonic device. In one embodiment the handheld device includes a software application that includes a wireless protocol to communicate with the telematics system 70, and the handheld device executes the extra-vehicle communication, including communicating with an off-board server via the wireless communication network 100. Alternatively, or in addition, the telematics system 70 may execute the extra-vehicle communication directly by communicating with the off-board server via the communication network.

The telematics system 70, which includes a wireless telematics communication system capable of extra-vehicle communications, including communicating with a communication network system having wireless and wired communication capabilities. The telematics system 70 is capable of extra-vehicle communications that includes short-range vehicle-to-vehicle (V2V) communication and/or vehicle-to-infrastructure communication, which may include communication with an infrastructure monitor, e.g., a traffic camera, or other intelligent highway systems. Alternatively, or in addition, the telematics system 70 has a wireless telematics communication system capable of short-range wireless communication to a handheld device, e.g., a cell phone, a satellite phone or another telephonic device. In one embodiment the handheld device is loaded with a software application that includes a wireless protocol to communicate with the telematics system 70, and the handheld device executes the extra-vehicle communication, including communicating with a second controller 96 that is housed at a remote facility 95 via a communication network that may include, e.g., a satellite 92, an antenna 91, and/or another communication mode. Alternatively, or in addition, the telematics system 70 executes the extra-vehicle communication directly by communicating with the second controller 96 via the communication network.

The remote facility 95 may include a data capture system having the second controller 96 that is located remote from the subject vehicle 10 and is capable of wirelessly communicating with the subject vehicle 10. In one embodiment, the second controller 96 is an element of a cloud-based computing system (cloud) 90. The second controller 96 may be part of the cloud 90 or another form of a back-office computing system associated with a service provider. The remote facility 95 includes a back-office advisor that is trained in conflict resolution and other related skills.

The telematics system 70 is configured to communicate with the remote facility 95. The first controller 15 is in communication with the spatial monitoring system 30, the microphone 32 and the audio speaker 33, the vehicle monitoring system 80, and the telematics system 70.

The term “cloud” and related terms may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

FIG. 2 pictorially shows an embodiment of the passenger cabin 20 for an embodiment of the subject vehicle 100, including the plurality of operator controls 25, the audio system 22 with at least one speaker 23, visual display system 24, and driver's seat 26. In one embodiment, the driver's seat 26 includes a plurality of haptic devices 27 disposed in a seat bottom and/or a seat back. The visual display system 24 is arranged as an electronic visual display device that is capable of electronic presentation of still images, text, and/or video in black-and-white and/or color formats. The visual display system 24 includes one or more of a driver information center, a head-up display, vehicle interior lighting, left and right sideview mirrors, a rear-view mirror, etc. Other elements may be related to the advanced driver assistance system (ADAS) 40, spatial monitoring system 30, navigation system 50 including global positioning system (GPS) sensor 52, human/machine interface (HMI) system 60, and telematics system 70. The visual display system 24 may be part of the HMI system 60 in one embodiment. In one embodiment, a microphone 32 is arranged to monitor audible sound within the passenger cabin 20 and around the exterior of the subject vehicle 100.

The term “controller” and related terms such as microcontroller, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component stores machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event.

Communication between controllers, actuators and/or sensors may be accomplished using a direct wired point-to-point link, a networked communication bus link, a wireless link or another suitable communication link. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers.

The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, which is capable of traveling through a medium. A parameter is defined as a measurable quantity that represents a physical property of a device or other element that is discernible using one or more sensors and/or a physical model. A parameter can have a discrete value, e.g., either “1” or “0”, or can be infinitely variable in value.

The terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

Referring now to FIG. 3, with continued reference to elements of an embodiment of the vehicle 100 that is described with reference to FIGS. 1 and 2, an interaction monitoring system 300 is described herein for an embodiment of the subject vehicle 100 that is described with reference to FIGS. 1 and 2. The interaction monitoring system 300 employs the spatial monitoring system 30 including a video camera 31 or other device that is capable of capturing internal and/or external images proximal to the subject vehicle; microphone 32 and audio speaker 33; telematics system 70, vehicle monitoring system 80; and controller 15 to capture data and effect audio or audiovisual communication between a vehicle operator, another person proximal to the vehicle 100 (such as a security person or a second party), and, in certain circumstances, a remotely located third-party advisor that may be trained in conflict resolution. The telematics system 70 is configured to communicate with the third-party advisor via the remote facility 95.

The interaction monitoring system 300 may be employed on-vehicle during a vehicle stopping event to address operator uncertainty during a pullover event. including employing situation-driven data collection to assess information from vehicle telematics and related on-board vehicle actions to assess the degree to which mutual security measures are maintained. This may include assessing the need for and facilitating intervention by a specially trained live advisor to mitigate interaction.

Overall, the interaction monitoring system 300 operates as follows. One or multiple on-vehicle controllers include one or multiple routines that are executable to periodically determine, via the vehicle monitoring system, a plurality of operating parameters for the subject vehicle, and detect occurrence of a vehicle stopping event, such as a pullover event that may be commanded or compelled by a security person in one occurrence. The plurality of operating parameters that are recorded during a predetermined period of time immediately preceding the vehicle stopping event are captured and saved. During the vehicle stopping event, the video camera and the microphone automatically capture and record interactions between the vehicle operator and a second party, e.g., the security person, or another person who may seek to engage the vehicle operator. The interaction between the vehicle operator and the second party (e.g., the security person) may be evaluated via an on-board routine, and a third-party advisor may be engaged via the telematics system based upon the interaction between the vehicle operator and the second party (e.g., the security person). The telematics system, the microphone and the audio speaker may be employed to effect communication between the vehicle operator, the second party (e.g., the security person), and the third-party advisor during the vehicle stopping.

The interaction monitoring system 300 operates as follows. During ongoing vehicle operation, the vehicle monitoring system 80 periodically monitors and captures a plurality of operating parameters 82 for the subject vehicle 100 and operator inputs to the operator controls 25 (Step 301).

Upon detection of occurrence of a vehicle stopping event that is initiated by a second party, such as a security person (Step 302), the plurality of operating parameters 82 are captured and recorded on-vehicle for a predetermined period of time immediately preceding the vehicle stopping event (Step 303). The occurrence of a vehicle stopping event that is initiated by a second party may be triggered by an operator input to the HMI device 60 in one embodiment. Alternatively, the occurrence of a vehicle stopping event that is initiated by a second party may be triggered automatically. The vehicle stopping event may be commanded by a security person in another vehicle, or a security person at a roadside checkpoint. The security person may include, by way of non-limiting examples, police, military, private security, forest/park ranger, fire service, etc. The second party may instead be a private individual.

During the vehicle stopping event, an interaction between the vehicle operator and the security person or second party is monitored via the video camera 31 and the microphone 32 of the spatial monitoring system 30 (Step 304), captured or stored (Step 305) and evaluated (Step 306).

Furthermore, the HMI system 60 may include a capability to capture and display verbal messages from the security person or second party. The verbal messages may be transcribed into a second language and captioned on the screen of the HMI system 60 in a language that is selected by the vehicle operator.

Furthermore, the telematics system 70 may determine, via the plurality of operator controls 25, information related to in-cabin activity in the subject vehicle 100 during the vehicle stopping event, with such information including, e.g., transmission range selector position (PRNDL) or status, a glove box open status, a vehicle operation status, a door open status, an interior cabin light status, etc.

Evaluating the interaction between the vehicle operator and the security person or second party (Step 305) may include executing an embodiment of the on-board speech analytics routine 400 to evaluate verbal interaction between the vehicle operator and the security person or second party. Evaluating the verbal interaction between the vehicle operator and the security person or second party may include detecting presence of verbal cues indicative of escalated or heightened tension or distress by the vehicle operator. Evaluating the verbal interaction between the vehicle operator and the security person or second party may include detecting presence of trigger words or key phrases by the vehicle operator that indicates the vehicle operator is requesting an intervention by a second party. Evaluating the verbal interaction between the vehicle operator and the security person or second party may include the vehicle operator expressly requesting an intervention by a third party.

A third-party advisor may be engaged via the telematics system (Step 308) when the on-board speech analytics routine 400 indicates heightened tension (Step 306(1)) or when the vehicle operator initiates a call to the third-party advisor (Step 307(1)). Otherwise (Step 306(0), audio and/or visual data is captured during the pullover event (Step 305).

The third-party advisor (Step 308) is engaged to interact with the vehicle operator and the security person or second party upon initiation of the call. Communication between the vehicle operator, the security person, and the third-party advisor may be effected during the vehicle stopping event via the telematics system 70, the microphone 32, the audio speaker 33, and in one embodiment, the video camera 31 or another element of the spatial monitoring system 30.

An automated message may also be generated and conveyed via the telematics system 70 to another party, such as an advisor, a family member, etc. during the interaction with the vehicle operator and the security person or second party (Step 308).

The call to the third-party advisor may continue during the span of time of the entire interaction with the vehicle operator and the security person or second party (Step 309), or may end at the request of the vehicle operator (Step 310).

Upon termination of the interaction with the vehicle operator and the security person or second party (Step 311), a summary report of the event may be captured, compiled (Step 312), and communicated to relevant parties (Step 313).

As such, prior to, during, and after a pullover event, internal and external cameras, microphones, radar, and related sensors are arranged to record pullover interaction.

The on-vehicle systems of the subject vehicle may actively catalogue operator behaviors, such as turn signal usage, vehicle speed, light functionality, phone usage, occurrence of tailgating, etc. to ensure an accurate depiction of driver and passenger activities. This information may be captured and recorded as part of the summary report of the pullover event.

The on-vehicle systems of the subject vehicle may evaluate driver behavior, including detecting the extent to which a driver is crossing over multiple lanes, double-yellow lines or demonstrated related activities consistent with unsafe driving. The on-vehicle systems of the subject vehicle 100 may detect occurrence of complete or full stop at signs and signals, hazard light usage and steering wheel engagement, including hands on/off. This information may be captured and recorded as part of the summary report of the pullover event.

The on-vehicle systems of the subject vehicle 100 may disengage operation of ADAS systems when a pullover event is recognized.

The on-vehicle systems of the subject vehicle 100 may display usage of a cell phone, the prohibition of which may be specific to a location/state/city.

The on-vehicle systems of the subject vehicle 100 may capture data such as door open/close, distance until the subject vehicle ceased movement after the pullover event was detected, ignition on/off, access to recessed areas on-vehicle, usage of interior cabin lights, door open/close status, vehicle PRNDL status, etc. This captured data may be conveyed to the security person in real-time, and may also be captured and recorded as part of the summary report of the pullover event.

During ongoing operation, the vehicle systems capture 45-60 seconds worth of video and telematics data, prior to recognition of a pullover event. This information may be captured and recorded as part of the summary report of the pullover event.

Occurrence of the active pullover event may be conveyed to other proximal vehicles via V2X communication.

Other on-board activities that may compromise security of law enforcement, such as excessive noise, may be displayed on the visual display system 24 or on the digital license plate 85.

Furthermore, exterior vehicle lights may indicate to approaching authorities what on-board vehicle activities (glovebox usage, PRNDL status) are active. Additionally, glovebox usage, speaker volume and passenger movement post-ignition may be displayed on the heads-up display (HUD) of the HMI system 60.

In one embodiment, the digital license plate 85 may be employed to display in-vehicle activities to ensure that approaching law enforcement is aware of changes to in-vehicle activities, including but not limited to activation of interior lights, number of passengers, access to a glovebox or another internal compartment, transmission range selector position (PRNDL), etc.

Furthermore, a post-incident pullover report may be compiled and shared with the vehicle operator. Furthermore, trunk security and vehicle weight may be included as part of post-incident pullover report.

The interaction monitoring system 300 is illustrated as a collection of blocks in a logical flow graph, which represents a sequence of operations that can be implemented in hardware, software, or a combination thereof. In the context of software, the blocks represent computer instructions that, when executed by one or more processors, perform the recited operations. Steps of the interaction monitoring system 300 may be executed in a suitable order, and are not limited to the order described with reference to FIG. 3.

The interaction monitoring system 300 and on-board speech analytics routine 400 of FIG. 3 is executed as algorithmic code in the first controller 15 employing executable instructions. The vehicle computing system may be implemented through a computer algorithm, machine executable code, non-transitory computer-readable medium, or software instructions programmed into a suitable programmable logic device(s) of the vehicle, such as the one or more modules, the entertainment module, a server in communication with the vehicle computing system, a mobile device communicating with the vehicle computing system and/or server, other controller in the vehicle, or a combination thereof. Although the various steps shown in the flowchart diagram appear to occur in a chronological sequence, at least some of the steps may occur in a different order, and some steps may be performed concurrently or not at all.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by dedicated-function hardware-based systems that perform the specified functions or acts, or combinations of dedicated-function hardware and computer instructions. These computer program instructions may also be stored in a computer-readable medium that can direct a computer or other programmable data processing apparatus to function in a particular manner, such that the instructions stored in the computer-readable medium produce an article of manufacture including instruction set that implements the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. An interaction monitoring system for a subject vehicle, comprising:
a spatial monitoring system including a video camera;
a microphone and an audio speaker;
a telematics system, the telematics system being configured to communicate with a remote facility;
a vehicle monitoring system; and
a controller, in communication with the spatial monitoring system, the microphone and the audio speaker, the vehicle monitoring system, and the telematics system;
the controller including an instruction set, the instruction set being executable to:
periodically determine, via the vehicle monitoring system, a plurality of operating parameters for the subject vehicle,
detect occurrence of a vehicle stopping event being commanded by a security person,
capture the plurality of operating parameters for a predetermined period of time immediately preceding the vehicle stopping event,
monitor, via the video camera and the microphone, an interaction between a vehicle operator and the security person,
evaluate the interaction between the vehicle operator and the security person,
engage a third-party advisor via the telematics system based upon the interaction between the vehicle operator and the security person, and
effect communication between the vehicle operator, the security person, and the third-party advisor during the vehicle stopping event via the telematics system, the microphone and the audio speaker.

2. The interaction monitoring system of claim 1, further comprising the instruction set being executable to:
capture the interaction between the vehicle operator and the security person; and
communicate, via the telematics system, the interaction between the vehicle operator and the security person to the remote facility subsequent to termination of the vehicle stopping event.

3. The interaction monitoring system of claim 1, further comprising the instruction set being executable to communicate, via the telematics system, the plurality of operating parameters for the predetermined period of time immediately preceding the vehicle stopping event to the remote facility subsequent to termination of the vehicle stopping event.

4. The interaction monitoring system of claim 1, wherein the instruction set includes a speech analytics routine, and wherein the instruction set being executable to evaluate the interaction between the vehicle operator and the security person comprises the speech analytics routine being executable to evaluate the interaction between the vehicle operator and the security person.

5. The interaction monitoring system of claim 4, wherein the instruction set is executable to engage the third-party advisor via the telematics system based upon an evaluation, by the speech analytics routine, of the interaction between the vehicle operator and the security person.

6. The interaction monitoring system of claim 5, wherein the instruction set is executable to engage the third-party advisor via the telematics system when the evaluation, by the speech analytics routine, of the interaction between the vehicle operator and the security person indicates an escalation of tension between the vehicle operator and the security person.

7. The interaction monitoring system of claim 5, wherein the instruction set is executable to engage the third-party advisor via the telematics system when the evaluation, by the speech analytics routine, of the interaction between the vehicle operator and the security person indicates the vehicle operator has requested engagement of the third-party advisor.

8. The interaction monitoring system of claim 1, wherein the telematics system includes a short-range communication system; wherein the short-range communication system effects vehicle-to-vehicle (V2V) communication; and wherein the controller is in communication with the telematics system to effect V2V communication with a proximal vehicle to convey occurrence of the vehicle stopping event for the subject vehicle.

9. The interaction monitoring system of claim 1, further comprising an electronic visual display in communication with the controller; wherein the controller, the microphone, the audio speaker, and the electronic visual display interact to present a visual display containing information related to the vehicle stopping event.

10. The interaction monitoring system of claim 9, further comprising the controller including a language interpretation routine, wherein the controller including the language interpretation routine, the microphone, the audio speaker, and the electronic visual display interact to present the visual display containing information related to the vehicle stopping event, wherein the visual display is translated to a second language upon detection that the vehicle operator is a non-English language speaker.

11. The interaction monitoring system of claim 1, further comprising the instruction set being executable to:
determine, via the vehicle monitoring system, in-cabin activity in the subject vehicle during the vehicle stopping event; and
communicate the in-cabin activity to the security person during the vehicle stopping event.

12. The interaction monitoring system of claim 11, wherein the instruction set being executable to determine the in-cabin activity in the subject vehicle during the vehicle stopping event comprises the instruction set being executable to detect at least one of a glove box open status, a vehicle operation status, a door open status, an interior cabin light status.

13. The interaction monitoring system of claim 12, wherein the instruction set being executable to detect the vehicle operation status comprises the instruction set being executable to detect a transmission range selector position.

14. An interaction monitoring system for a subject vehicle, comprising:
a video camera;
a microphone and an audio speaker;
a telematics system, the telematics system being configured to communicate with a remote facility;
a vehicle monitoring system; and
a controller, in communication with the video camera, the microphone and the audio speaker, the vehicle monitoring system, and the telematics system;
the controller including an instruction set, the instruction set being executable to:
periodically determine, via the vehicle monitoring system, a plurality of operating parameters for the subject vehicle,
detect occurrence of a vehicle stopping event;
capture the plurality of operating parameters for a predetermined period of time immediately preceding the vehicle stopping event,
monitor, via the video camera and the microphone, an interaction between a vehicle operator and a second person,
evaluate the interaction between the vehicle operator and the second person,
engage a third-party advisor via the telematics system based upon the interaction between the vehicle operator and the second person, and
effect communication between the vehicle operator, the second person, and the third-party advisor during the vehicle stopping event via the telematics system, the microphone, and the audio speaker.

15. The interaction monitoring system for the subject vehicle of claim 14, further comprising the instruction set being executable to effect communication between the vehicle operator, the second person, and the third-party advisor during the vehicle stopping event via the telematics system, the video camera, the microphone, and the audio speaker.

16. The interaction monitoring system of claim 14, further comprising the instruction set being executable to:
capture the interaction between the vehicle operator and the second person; and
communicate, via the telematics system, the interaction between the vehicle operator and the second person to the remote facility subsequent to termination of the vehicle stopping event.

17. The interaction monitoring system of claim 14, further comprising the instruction set being executable to communicate, via the telematics system, the plurality of operating parameters for the predetermined period of time immediately preceding the vehicle stopping event to the remote facility subsequent to termination of the vehicle stopping event.

18. The interaction monitoring system of claim 14, wherein the instruction set includes a speech analytics routine, and wherein the instruction set being executable to evaluate the interaction between the vehicle operator and the second person comprises:
the speech analytics routine being executable to evaluate the interaction between the vehicle operator and the second person; and
engage the third-party advisor via the telematics system based upon the evaluation, by the speech analytics routine, of the interaction between the vehicle operator and the second person.

19. The interaction monitoring system of claim 14, further comprising an electronic visual display in communication with the controller; wherein the controller, the microphone, the audio speaker, and the electronic visual display interact to present a visual display containing information related to the vehicle stopping event.

20. An interaction monitoring system for a subject vehicle, comprising:
a microphone and an audio speaker;
a telematics system, the telematics system being configured to communicate with a remote facility;
a vehicle monitoring system; and
a controller, in communication with the microphone and the audio speaker, the vehicle monitoring system, and the telematics system;
the controller including an instruction set, the instruction set being executable to:
periodically determine, via the vehicle monitoring system, a plurality of operating parameters for the subject vehicle,
detect occurrence of a vehicle stopping event;
capture the plurality of operating parameters for a predetermined period of time immediately preceding the vehicle stopping event,
monitor, via the microphone, an interaction between a vehicle operator and a second person, and
communicate the interaction between the vehicle operator and the second person to the remote facility via the telematics system.
